(19) United States
(12) Patent Application Publication
(10) Pub. No.: US 2011/0242712 A1
(43) Pub. Date: Oct. 6, 2011

(54) CHIP WITH ESD PROTECTION FUNCTION

(76) Inventors: Fwu-Juh Huang, Taoyuan County (TW); Bo-Shih Huang, Kaohsiung City (TW)

(21) Appl. No.: 12/753,061

(22) Filed: Apr. 1, 2010

(51) Int. Cl. H02H 9/00

(52) U.S. Cl. 361/56

(57) ABSTRACT

An exemplary chip includes an input/output (I/O) area and a core area is provided. The input/output (I/O) area has a first I/O block operated under a first power domain and a second I/O block operated under a second power domain placed therein, wherein a voltage range of the first power domain is distinct from a voltage range of the second power domain. The core area has at least one circuit therein performing at least one function of the chip, and the core area further has at least one power cut cell placed therein wherein the power cut cell is coupled to the first I/O block and the second I/O block via a plurality of connectors for providing an electrostatic discharge (ESD) path between the first I/O block and the second I/O block.

### BACKGROUND

The present invention relates to ESD (Electrostatic Discharge) circuits in integrated circuit (IC) designs, and more particularly, to ESD (protection) cell placements and pad ring assignments of integrated circuits.

In integrated circuit designs, providing protection device(s) having an ESD protection function to protect the circuit structures is required, and a power cut circuit/cell is an ESD device used in the I/O area of the chip for connecting two different I/O blocks/power domains therein to thereby provide ESD protections. Since one single chip may have multiple power domains due to different design requirements, such as power-down, multiple supply voltages, and noise isolation, the required numerous power cut circuits thereby may cause the large chip size and the increased cost.

Please refer to FIG. 1A; FIG. 1A is a diagram illustrating a circuit 100 having a power cut functionality according to the related art. The circuit 100 can be a circuit disposed at an I/O area of a chip, and the circuit 100 includes several I/O blocks (e.g., a first I/O block 130, a second I/O block 140, and a third I/O block 150), and the circuit 100 further includes a first power cut block 110 and a second power cut block 120. Here each of the I/O blocks (I/O blocks 130, 140 and 150) includes a plurality of I/O cells and corresponding ESD clamp circuits (not shown), and, VDD1, VDD2, and VDD3 are separated power nets while VSS1, VSS2, and VSS3 are separated ground nets. The first power cut block 110 cuts signal coupling between the first I/O block 130 and the second I/O block 140, while the second power cut block 120 cuts signal coupling between the second I/O block 140 and the third I/O block 150. Each of the I/O blocks can correspond to a particular power domain distinct from the others, that is, a voltage range (e.g. the supply voltage, the ground voltage or a voltage difference between the supply voltage and the ground voltage) of each I/O block could be different from that of the others.

While an ESD event occurs, the discharging current may flow between any two power domains, for example, from the power net VDD1 (corresponding to the first power domain) to the ground net VSS2 (corresponding to the second power domain), then the first power cut block 110 works as a connector between the ground nets VSS1 and VSS2 to provide an ESD path, thereby protecting the core circuit from being damaged by the large discharging current.

However, if a chip has numerous power domains in the I/O area, the required power cut devices may cause the chip size and cost raised, especially when the chip is a pad-limited chip. According to the corresponding design issues, chips can be divided into pad-limited chips and core-limited chips according to the core/pad areas. For instance, if the overall size of a chip mainly depends upon the core area size, the chip is a “core-limited” chip; on the contrary, when the size of the chip mainly depends upon the I/O area, the chip is a “pad-limited” chip. The multiple power cut cells for providing ESD paths between different power domains at the I/O circuits will become an unpleasant factor for the increased chip size, especially when the pad ring (I/O area) is a critical factor for determining the chip area and the pad limited chip has a plurality of power domains therein. Please refer to FIG. 1B. FIG. 1B is a diagram illustrating a traditional circuit having ESD protection functionality according to the related art, wherein the circuit 200 illustrates a portion of a chip, but not a complete chip. As mentioned above, traditionally the power cut cells are assigned on the pad ring (the I/O area of a chip) and each power cut cell is sandwiched in between two I/O blocks corresponding to distinct power domains, respectively. As shown in FIG. 1B, the conventional circuit 200 includes a core area 210 and an I/O area 220 which includes two I/O blocks (e.g., a first I/O block 230 and a second I/O block 240) and a first power cut cell 250 sandwiched in between the first I/O block 230 and the second I/O block 240. Based on the practical design requirements, the first power cut cell 250 may have two connecting ends or four connecting ends connected to the first I/O block 230 and the second I/O block 240. For a chip which has more power domains, the circuit 200 may include more I/O blocks, more power cut cells and thus results in increased chip size.

To achieve the objective for providing a small-sized chip with admirable ESD functions, it is demanded to provide a new chip structure for providing ESD protection device to supply ESD paths between different power domains for protecting I/O blocks and other circuit structures of the chip while having the chip size issue taken into consideration.

### SUMMARY OF THE INVENTION

According to a first exemplary embodiment of the present invention, a chip is provided. The exemplary chip includes an input/output (I/O) area and a core area. The I/O area has a first I/O block operated under a first power domain and a second I/O block operated under a second power domain placed therein, wherein a voltage range of the first power domain is distinct from a voltage range of the second power domain. The core area has at least one circuit therein performing at least one function of the chip, and the core area further has at least one power cut cell placed therein where the power cut cell is coupled to the first I/O block and the second I/O block via a plurality of connectors for providing an electrostatic discharge (ESD) path between the first I/O block and the second I/O block.

According to a second exemplary embodiment of the present invention, an exemplary chip is provided. The exemplary chip includes a plurality of I/O blocks and at least one power cut cell. The plurality of I/O blocks include a first I/O block and a second I/O block operated under a first power domain and a second power domain, respectively, wherein a voltage range of the first power domain is distinct from a voltage range of the second power domain. The at least one power cut cell is coupled to the first I/O block and the second I/O block via a plurality of connectors for providing an electrostatic discharge (ESD) path between the first I/O block and the second I/O block, where the at least one power cut cell is not sandwiched in between the first I/O block and the second I/O block.

According to a third exemplary embodiment of the present invention, a chip is provided. The exemplary chip includes an input/output (I/O) area and a core area. The I/O area has a first I/O block and a second I/O block placed therein operated under a same power domain. The core area has at least one circuit therein performing at least one function of the chip, and the core area further has at least one power cut cell placed therein wherein the power cut cell is coupled to the first I/O block and the second I/O block via a plurality of connectors for providing an electrostatic discharge (ESD) path between the first I/O block and the second I/O block.

According to a fourth exemplary embodiment of the present invention, an exemplary chip is provided. The exemplary chip includes a plurality of I/O blocks and at least one power cut cell. The plurality of I/O blocks include a first I/O block and a second I/O block operated under a same power domain. The at least one power cut cell is coupled to the first I/O block and the second I/O block via a plurality of connectors for providing an electrostatic discharge (ESD) path between the first I/O block and the second I/O block, where the at least one power cut cell is not sandwiched in between the first I/O block and the second I/O block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating a circuit with power cut functionality according to the related art.

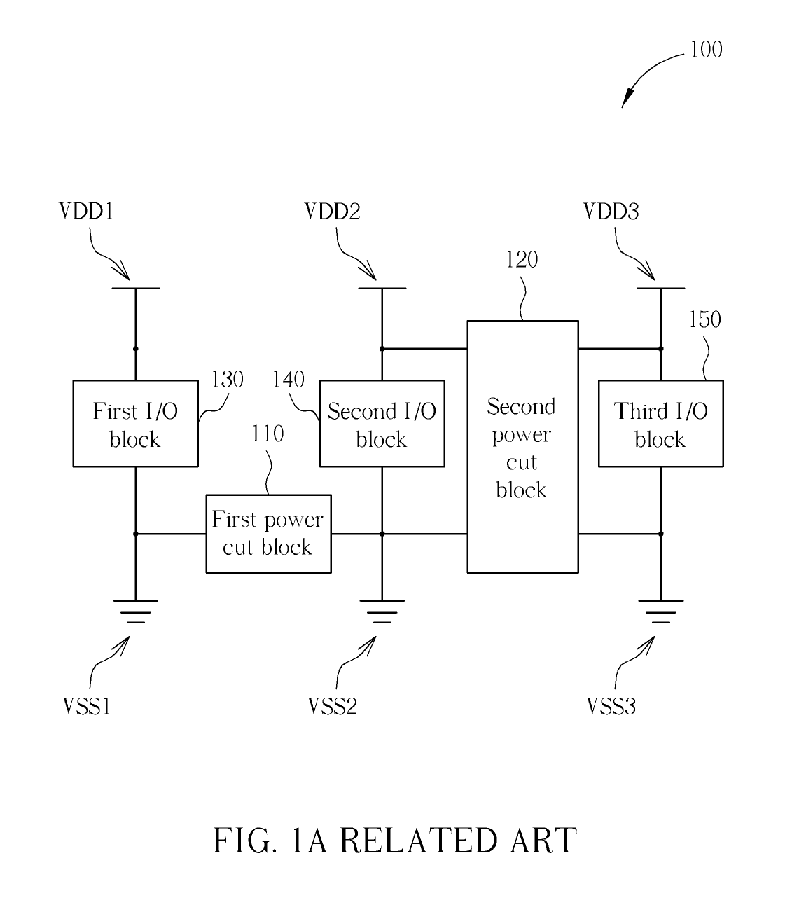

FIG. 1B is a diagram illustrating a traditional circuit having ESD protection functionality according to the related art.

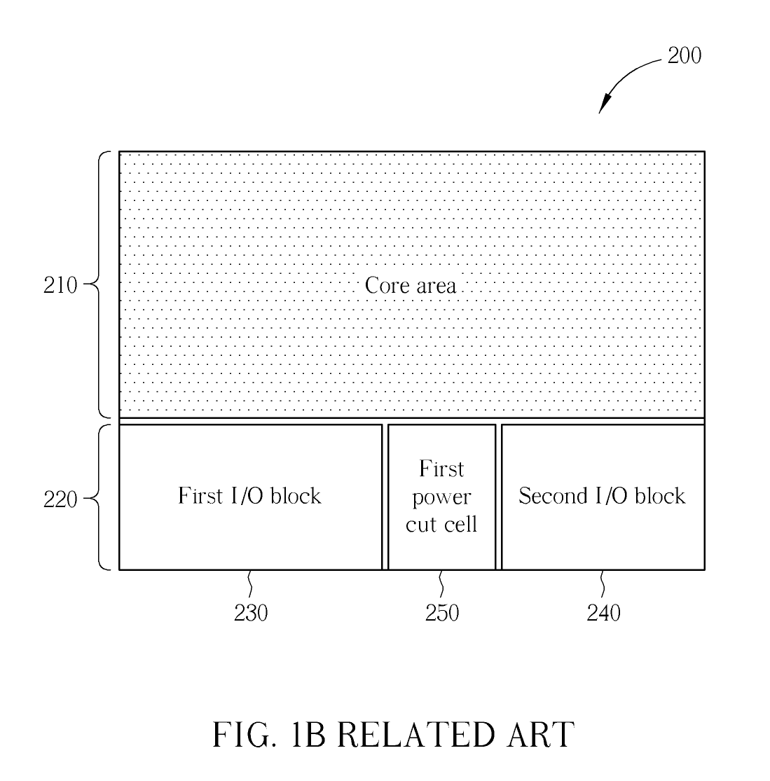

FIG. 2 is a top view diagram illustrating a chip of the present invention.

FIG. 3 is a diagram illustrating implementation details of a partial structure of the chip in FIG. 2 according to a first exemplary embodiment of the present invention.

FIG. 4 is a diagram illustrating variations of the implantation details of a partial structure of the chip in FIG. 2 according to a second exemplary embodiment of the present invention.

FIG. 5 is a diagram illustrating variations of the implantation details of a partial structure of the chip in FIG. 2 according to a third exemplary embodiment of the present invention.

FIG. 6 is a diagram illustrating variations of the implantation details of a partial structure of the chip in FIG. 2 according to a fourth exemplary embodiment of the present invention.

FIG. 7 is a diagram illustrating variations of the implantation details of a partial structure of the chip in FIG. 2 according to a fifth exemplary embodiment of the present invention.

FIG. 8 is a diagram illustrating a power cut cell having two connecting nodes according to an exemplary embodiment of the present invention.

FIG. 9 is a diagram illustrating a power cut cell having four connecting nodes according to an exemplary embodiment of the present invention

FIG. 10 is a diagram illustrating a power cut cell having four connecting nodes according to another exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

For solving the aforementioned problems encountered in the conventional chip designs, exemplary embodiments of the present invention provides a chip having power cut cells disposed in core area for providing ESD paths between power domains of the I/O area of a chip, thereby realizing a novel chip design providing excellent ESD protection functionality and having further reduced chip area.

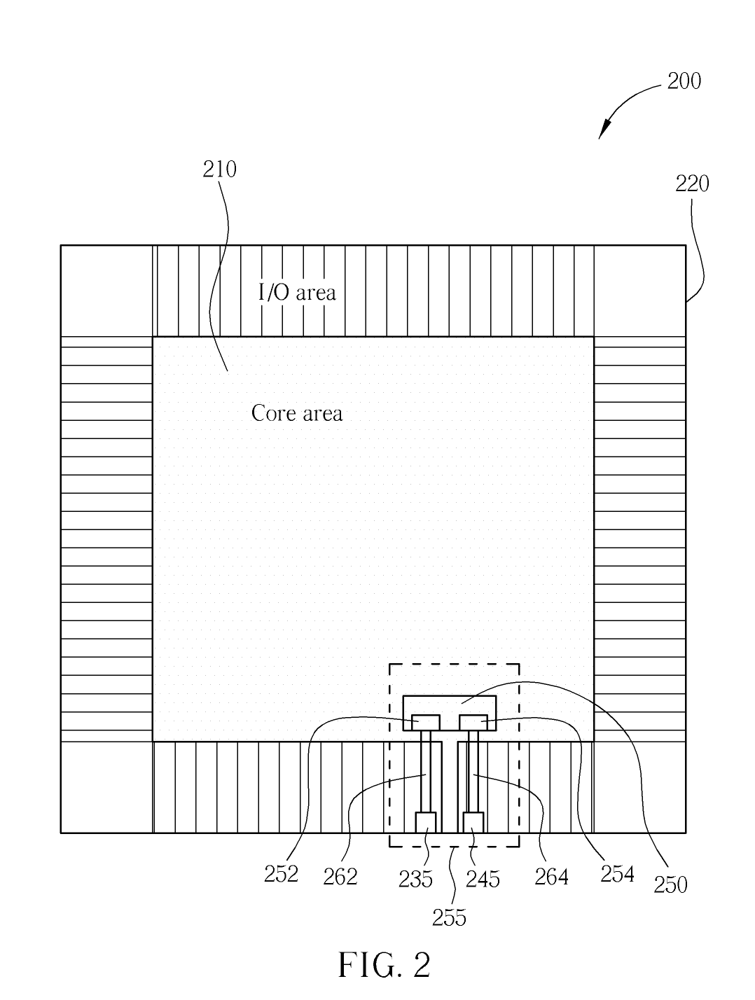

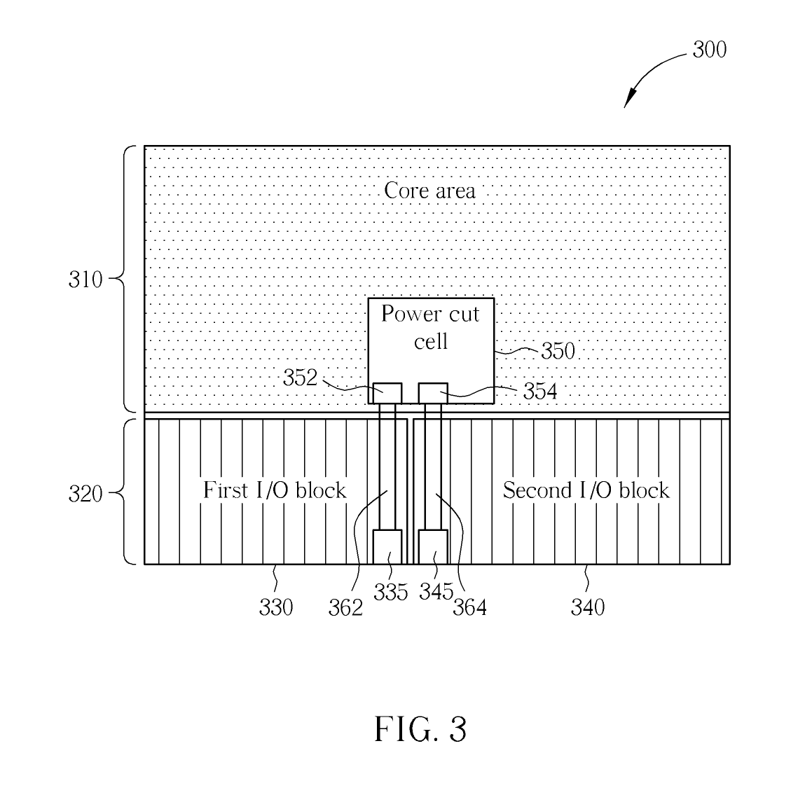

Please refer to FIG. 2. FIG. 2 is a top view diagram illustrating a chip according to an exemplary embodiment of the present invention. The chip 200 includes a core area 210 and an I/O area 220, and 255 represents a portion of the chip 200. As well known by people skilled in this art, the I/O area 220 represents the peripheral area of a chip 200 where the circuit(s) (not shown) therein transmits signals to and receive signals from outside of the chip 200. Besides, a core area 210 has at least one circuit therein which performs at least one function of the chip 200; where the circuit(s) (not shown) in the core area 210 is not in charge of receiving signals from outside of the chip 200 and not in charge of outputting signals outside with keeping proper signal quality. The circuit(s) in the core area 210 gets signals from the circuit(s) in the I/O area 220, processes the signals to perform functions and sends the processed signals to the circuit(s) in the I/O area 220. Please note FIG. 2 is used for illustrative purpose only and not meant to be a limitation of the present invention. For example, in the aforementioned embodiment, the portion 255 of the chip 200 is representatively at the bottom right side of the chip 200; however, in variations of the present invention, the portion 255 can be at any side of the chip, such as the up right side, the up left side, the bottom left side of the chip 200. The portion 255 may include a power cut cell 250 placed inside the core area 210, and connecting between two I/O blocks in the I/O area 220 via connecting units 235, 245, 252, 254, 262 and 264, thereby providing ESD paths between I/O blocks of the I/O area 210 of the chip, further descriptions of the operations of the portion 255 having power cut cell(s) placed inside the core area 210 are disclosed in the following paragraphs. Please refer to FIG. 3 in conjunction with FIG. 2. FIG. 3 is a diagram illustrating implementation details of a partial structure of the chip in FIG. 2 according to a first exemplary embodiment of the present invention. Here the partial structure 300 is a portion of the chip 200, moreover, the partial structure 300 can be used to represent the portion 255 in FIG. 2. The partial structure 300 includes a core area 310 and an I/O area 320. To achieve the chip area sizing down objective even when the chip 200 which the partial structure 300 belongs corresponds to the pad limited design, a power cut cell 350 for providing ESD paths between different I/O blocks operated under different power domains now is arranged in the core area 310 instead of the I/O area 320, thereby reducing a girth of the pad ring and the size of the chip 200 the partial structure 300 belonging. As well known by people skilled in this art, circuits corresponding to a same power domain are operated under same operating voltage(s). Particularly, circuits corresponding to the same power domain have operating voltage(s) which turns on/turns off/rises/falls down identically. A power domain can include a plurality of I/O blocks.

In FIG. 3, a first I/O block 330 corresponds to a first power domain and a second I/O block 340 corresponds to a second power domain where the second power domain is distinct from the first power domain, and the I/O blocks are provided with ESD path(s) via the power cut cell 350. However, the perimeter of the required pad ring is now reduced by placing the power cut cell 350 in the core area 310. Therefore, the chip size can be reduced especially when the chip 200 the partial structure 300 belonging is pad-limited chip, then the reduction of the chip area may be more significant if there are more power domains in the I/O area 320. In this exemplary embodiment, the partial structure 300 of the chip 200 includes a first connector 362 and a second connector 364, which connect the power cut cell 350 with a first ground node 335 in the first I/O block 330 and connect the power cut cell 350 with a second ground node 345 in the second I/O block 340, respectively. However, as well known by people skilled in this art, the power cut cell 350 could have two connecting nodes or four connecting nodes for connecting the power nodes/ground nodes of two adjacent I/O blocks. Illustratively, the power cut cell 350 includes a first connecting node 352 coupled to the first ground node 335 of the first I/O block 330, and the power cut cell 350 further includes a second connecting node 354 coupled to the second ground node 345 of the second I/O block 340 via respective connectors 362 and 364. However, the aforementioned connecting manners and the circuit structures of the chip and the power cut cells are for illustrative purposes only, and are not meant to be a limitation to the scope of the present invention. For example, the types of the first connector 362 and the second connector 364 may vary according different design requirements, such as using the metal layer structure to form the required connectors.

In addition, in different embodiments, the connectors may not be restricted to connect the ground nodes of different power domains, but connect the power nodes of different power domains. Moreover, the power cut cell 350 may have connecting nodes to connect to the power nodes and the ground nodes of two different power domains, to thereby provide different ESD paths.

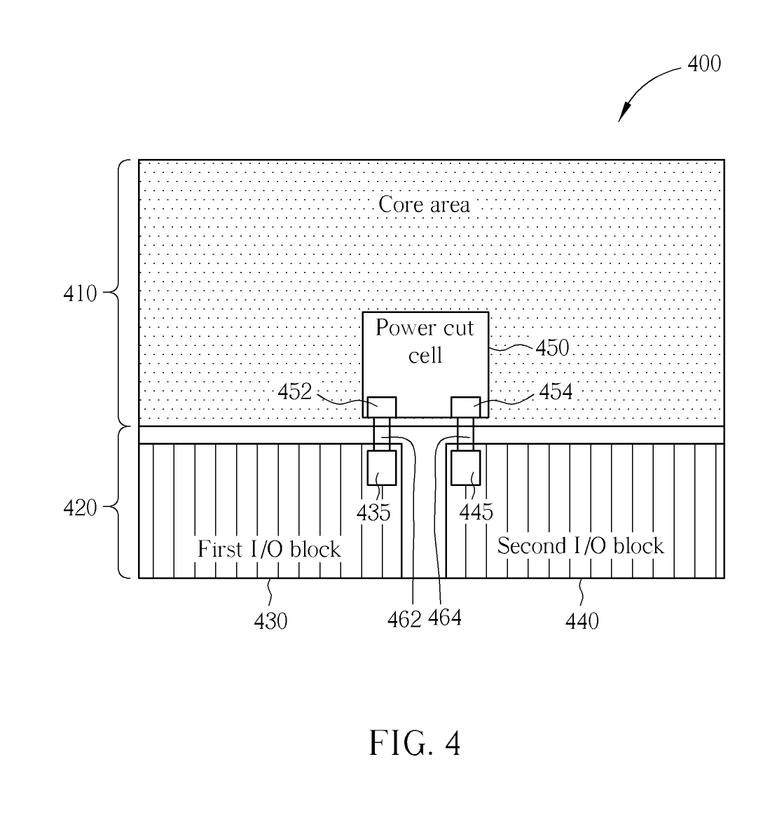

Please note that the chip 200 may have numerous I/O blocks and corresponding power cut cells in other embodiments. These alternative designs obey and fall with in the scope of the present invention. More exemplary embodiments will be disclosed in the following descriptions. Please refer to FIG. 4 in conjunction with FIG. 2; FIG. 4 is a diagram illustrating variations of the implementation derails of a partial structure of the chip in FIG. 2 according to a second exemplary embodiment of the present invention. The partial structure 400 includes a core area 410 and an I/O area 420. For example, the partial structure 400 can be used to represent the implementation detail of the portion 255 in FIG. 2. The I/O area 420 includes at least a first I/O block 430 and a second I/O block 440. A power cut cell 450 for providing ESD protections between circuits in different power domains is placed in the core area 410, where a voltage range of a first power domain to which the first I/O block 430 belongs is different from that of a second power domain corresponding to the second I/O block 440.

In fact, the main difference between the partial structure 300 and the partial structure 400 is that, the power cut cell 450 in this exemplary embodiment is coupled to the first I/O block 430 and the second I/O block 440 via a first connector 462 and a second connector 464 through a first power node 435, a second power node 445, a first connecting node 452, and a second connecting node 454. Since all the circuit structure and the operations of the chip having power cut cell placed in the core area for providing ESD paths between different power domains have been clearly disclosed above, further descriptions are omitted here for the sake of brevity.

However, the locations of the ground nodes and the power nodes in FIG. 3 and FIG. 4 are for illustrative purposes only and not meant to be limitations of the present invention. The power nodes/ground nodes can be allocated at any places of the corresponding I/O blocks; all the alternative designs of the ground nodes/power nodes with different locations for connecting the connecting nodes via the connectors obey the spirit of the present invention and fall within the scope of the present invention.

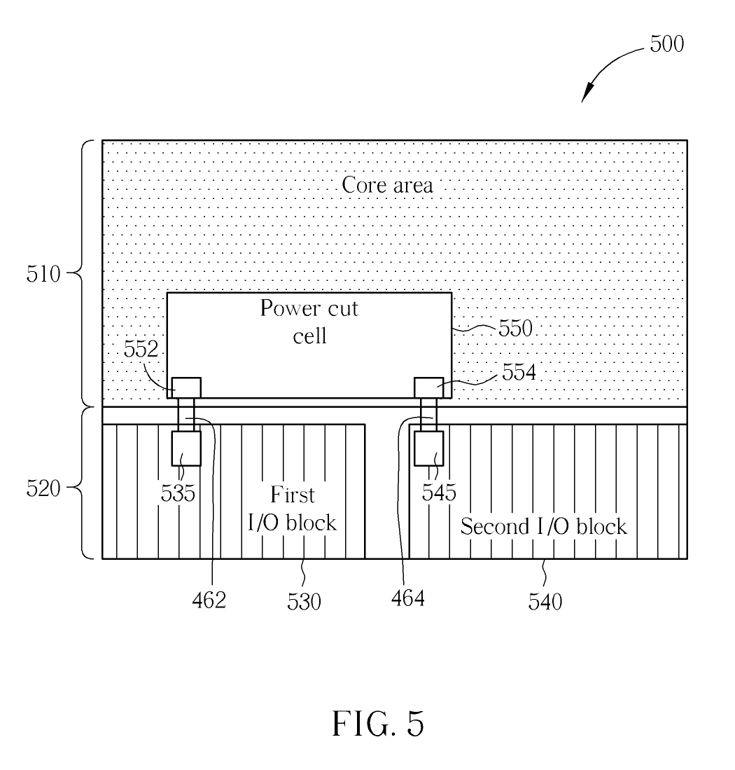

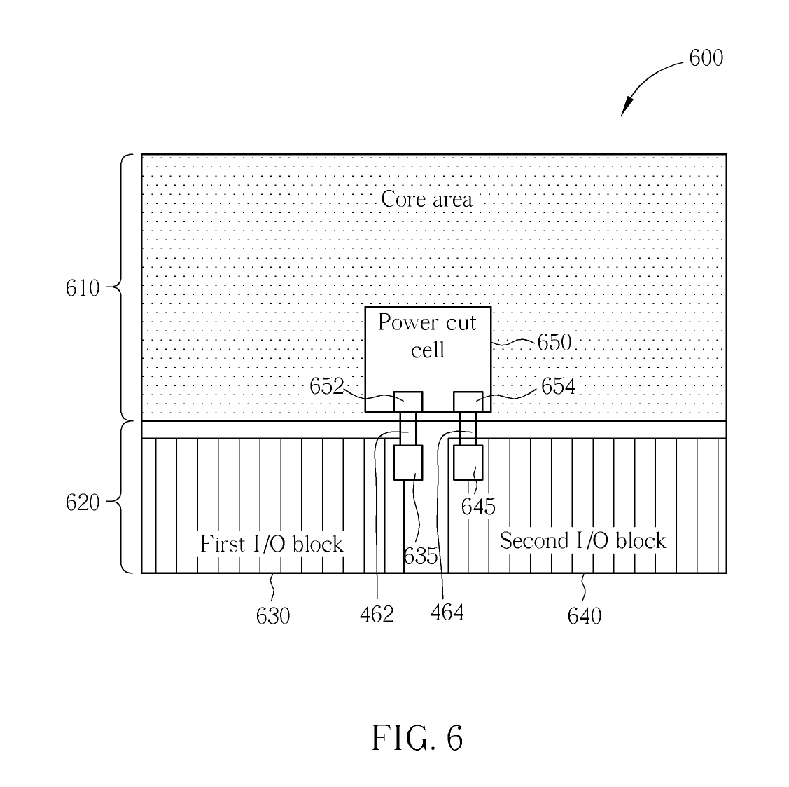

Please refer to FIG. 5 and FIG. 6 in conjunction with FIG. 2. FIG. 5 is a diagram illustrating variations of the implantation details of a partial structure of the chip in FIG. 2 according to a third exemplary embodiment of the present invention; FIG. 6 is a diagram illustrating variations of the implantation details of a partial structure of the chip in FIG. 2 according to a fourth exemplary embodiment of the present invention. The partial structure 500 includes a core area 510 and an I/O area 520. For example, the partial structure 500 can be used to represent the implementation detail of the portion 255 in FIG. 2. The I/O area 520 includes at least a first I/O block 530 and a second I/O block 540. A power cut cell 550 for providing ESD protections between I/O blocks in different power domains is placed in the core area 510, where a voltage range of a first power domain to which the first I/O block 530 belongs is different from that of a second power domain corresponding to the second I/O block 540.

The main difference between the partial structure 500 and the partial structure 400 is that, the location of the first power node 535 corresponding to the first I/O block 530, and that of the second power node 545 corresponding to the second I/O block 540. Moreover, the place of the first connector 462 and the second connector 464 varies corresponding to that of the first power node 535/second power node 545 respectively, and so as the places of the first connecting node 552 and the second connecting node 554. In FIG. 6, the partial structure 600 includes a core area 610 and an I/O area 620. For example, the partial structure 600 can be used to represent the implementation detail of the portion 255 in FIG. 2. The I/O area 620 includes at least a first I/O block 630 and a second I/O block 640. A power cut cell 650 for providing ESD protections between I/O blocks in different power domains is placed in the core area 610, where a voltage range of a first power domain to which the first I/O block 630 belongs is different from that of a second power domain corresponding to the second I/O block 640. In addition, here the location of the first power node 635 corresponding to the first I/O block 630, and, the location of the second power node 645 corresponding to the second I/O block 640 are different from the previous embodiments; moreover, the place of the first connector 462 and the second connector 464 varies corresponding to that of the first power node 635/second power node 645 respectively. By properly adjusting the places of the first connecting node 652 and the second connecting node 654 to match the places of the first power node 635/second power node 645 to ensure the functionality of the ESD protection between power domains, the places/locations of the connecting node, power nodes, ground nodes and connectors can vary; and the alternative designs obey and fall within the scope of the present invention. Since all the circuit structure and the operations of the chip having power cut cell placed in the core area for providing ESD paths between different power domains have been clearly disclosed above, further descriptions are omitted here for the sake of brevity. Moreover, other embodiments of chips using ground nodes for connecting to the power cut cell via the connecting nodes and connectors can adjust the locations of the ground nodes/connectors according to different design requirements; since the alternative designs can be easily understood after reading the aforementioned embodiments, further description is omitted here for the sake of briefness.

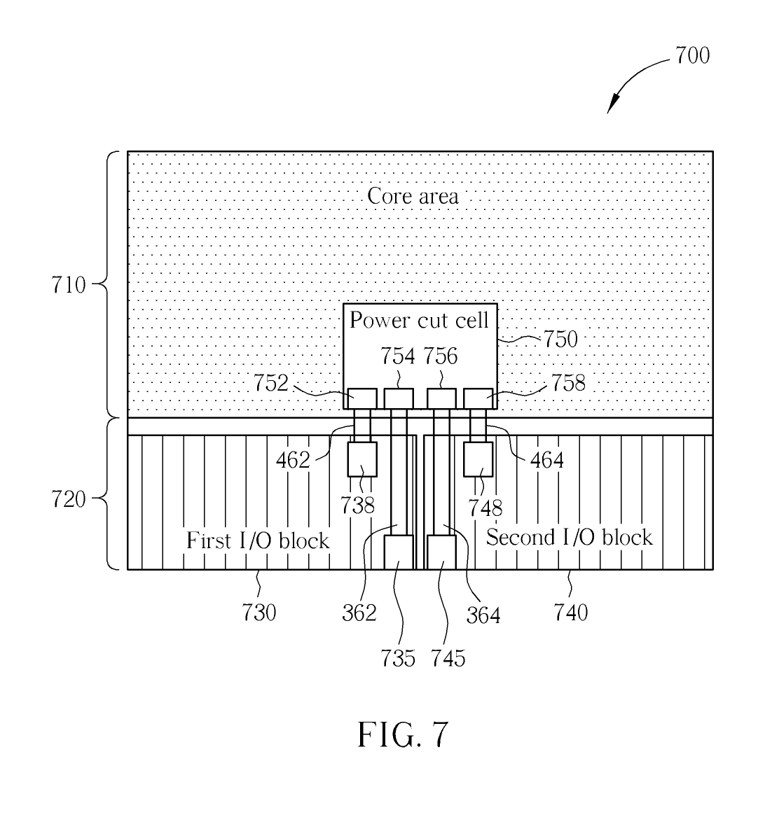

Please refer to FIG. 7. FIG. 7 a diagram illustrating variations of the implantation details of a partial structure of the chip in FIG. 2 according to a fifth exemplary embodiment of the present invention. The partial structure 700 has a core area 710 and an I/O area 720. The I/O area 720 has a first I/O block 730 operating under a first power domain and a second I/O block 740 operating under a second power domain different from the first power domain. A power cut cell 750 having four connecting nodes 752, 754, 756, and 758, where the connectors 462 and 464 are connected to a first power node 738 and a second power node 748, respectively, and the connectors 362 and 364 are connected to a first ground node 735 and a second ground node 745, respectively. The main difference between the implementation details of the partial structure 700 and partial structures 300, 400 is the power cut cell 750 having different ESD paths established by four connecting nodes 752, 754, 756, and 758. For example, when there is an ESD event happened from the power node 738 of the first I/O block 730 to the second I/O block 740; the ESD current may selectively passing through the ESD path from the first power node 738 of the first I/O block 730 to the second power node 748 of the second I/O block 740 via the first power node 738, the connector 462, the first connecting node 752, the fourth connecting node 758, the connector 464 and the second power node 748; or, the ESD current may selectively passing through the ESD path from the first power node 738 of the first I/O block 730 to the second ground node 745 of the second I/O block 740 via the first power node 738, the connector 462, the first connecting node 752, the third connecting node 756, the connector 364 and the second ground node 745. Moreover, when the ESD event needs a path from the second I/O block 740 to the first I/O block 730; the ESD current can selectively passing from the second power node 748 of the second power domain corresponding to the second I/O block 740 to the first power node 738 of first power domain corresponding to the first I/O block 730, or, passing from the second power node 748 of the second power domain corresponding to the second I/O block 740 to the first ground node 735 of first power domain corresponding to the first I/O block 730.

Furthermore, the chip having the implementation details illustrated in FIG. 7 can also provide an ESD path through the first ground node 735 of the first I/O block 730 to the second ground node 745 of the second I/O block 740 via the first ground node 735, the connector 362, the second connecting node 754, the third connecting node 756, the connector 364, and the second ground node 745. Since other ESD path(s) and the corresponding elements of the ESD paths can be easily known by reading the aforementioned paragraphs, further description are therefore omitted for the sake of brevity.

The number of the power domains and corresponding power cut cell(s) can vary. For example, when a partial structure of the chip includes three I/O blocks (a first I/O block, a second I/O block and a third I/O block) each belonging to different power domain, there could be two power cut cells (first power cut cell and the second power cell) placed in the core area for providing ESD protections. Where the first power cut cell placed in the core area can be used for providing ESD path(s) between the first I/O block and the second I/O block, and the second power cut cell placed in the core area can be used for providing ESD path(s) between the second I/O block and the third I/O block. In short, the present invention provides chips having a plurality of I/O blocks belonging to different power domains and corresponding power cut cells placed in the core area for providing ESD protections between different power domains. All the alternative designs obey and fall within the scope of the present invention.

For ensuring the protection robustness, a total width of each of the connectors of the present invention is preferred to fit an ESD tolerance level. For instance, if the ESD tolerance level is set to be not less than 500V of the human body model (HBM), the total width of each of the connectors can be not less than 5 um. Moreover, when the chip of the present invention is set to further correspond to an ESD tolerance level of not less than 50V of the machine model, the total width of each of the connectors can be not less than 5 um; when the chip of the present invention is set to further correspond to an ESD tolerance level of not less than 50V of the charged device model, the total width of each of the connectors can be not less than 5 um.

In addition, a resistance of a connector can be kept less than a threshold resistance. That is to say, the resistance corresponding to the first connecting node 352, the first connector 362, and the first ground node 355 in FIG. 3 can be set less than 5 ohm in some embodiments; in some particular examples, the said corresponding resistance can be further set less than 1 ohm with different design requirements.

The structures/types of the connectors are not meant to be a limitation of the present invention. Taking the partial structure 300 of the chip 200 for example, the first connector 362 and the second connector 364 can be assembled by either a single metal layer or multiple metal layers, as long as the total width of each connector fits the ESD tolerance level. For example, if the required total width is not less than 5 um according to the preferred ESD tolerance level, the connector can be formed by two metal lines respectively routed on two metal layers and the width of each of the metal lines is not less than 2.5 um, or formed by four metal lines respectively routed on four metal layers and the width of each of the metal lines is not less than 1.25 um, depending on the design requirements. Or, the connectors can be formed by a plurality of metal lines routed on the same layer according to different design requirements. For example, if the required total width is not less than 5 um according to the preferred ESD tolerance level, the connector can be formed by two metal lines routed on the same metal layer and the width of each of the metal lines is not less than 2.5 um. In addition, in some embodiments of the present invention, the connectors of the chips can be other connecting means but not restricted to be metal layer connections. By slightly adjusting the manufacture processes, in some cases a bonding wire can be used to serve as the connectors for connecting the power cut cell to different power domains. The alternative designs obey and fall within the scope of the present invention.

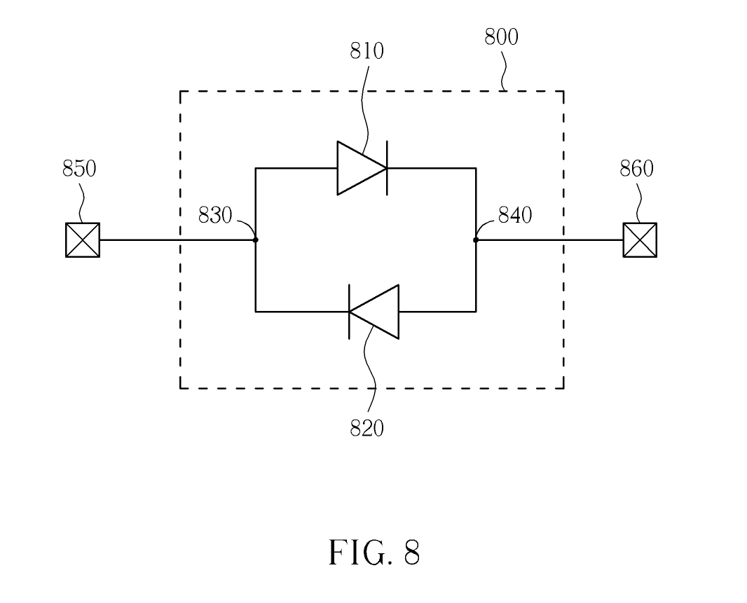

Please refer to FIG. 8. FIG. 8 is a diagram illustrating a power cut cell having two connecting nodes according to an exemplary embodiment of the present invention. The exemplary power cut cell 800 has a first diode 810, a second diode 820, a first connecting node 830 and a second connecting node 840. The first connecting node 830 and the second connecting node 840 can be connected to power nodes of two different power domains or ground nodes of two different power domains according to the design requirements. In other words, the power cut cell 350 of FIG. 3 and the power cut cell 450 of FIG. 4 can be implemented by the power cut cell 800, and the nodes 850 and 860, wherein the nodes 850 and 860 correspond to the power nodes or ground nodes of the I/O blocks. For example, in the case corresponding to FIG. 3, the first connecting node 830 corresponds to the first connecting node 352, the second connecting node 840 corresponds to the second connecting node 354, the node 850 corresponds to the first ground node 335 and the node 860 corresponds to the second ground node 345 in FIG. 3. Or, in the case corresponding to FIG. 4, the first connecting node 830 corresponds to the first connecting node 452, the second connecting node 840 corresponds to the second connecting node 454, the node 850 corresponds to the first power node 435 and the node 860 corresponds to the second power node 445 in FIG. 4.

However, the exemplary structure of the power cut cell 800 is for illustrative purposes only and not meant to be a limitation to the scope of the present invention; that is, all the alternative designs of the power cut cell, placed in the core area or not sandwiched in between I/O blocks in the I/O area, for coupling two different power domains to provide ESD paths required by ESD protections obey and fall within the scope of the present invention.

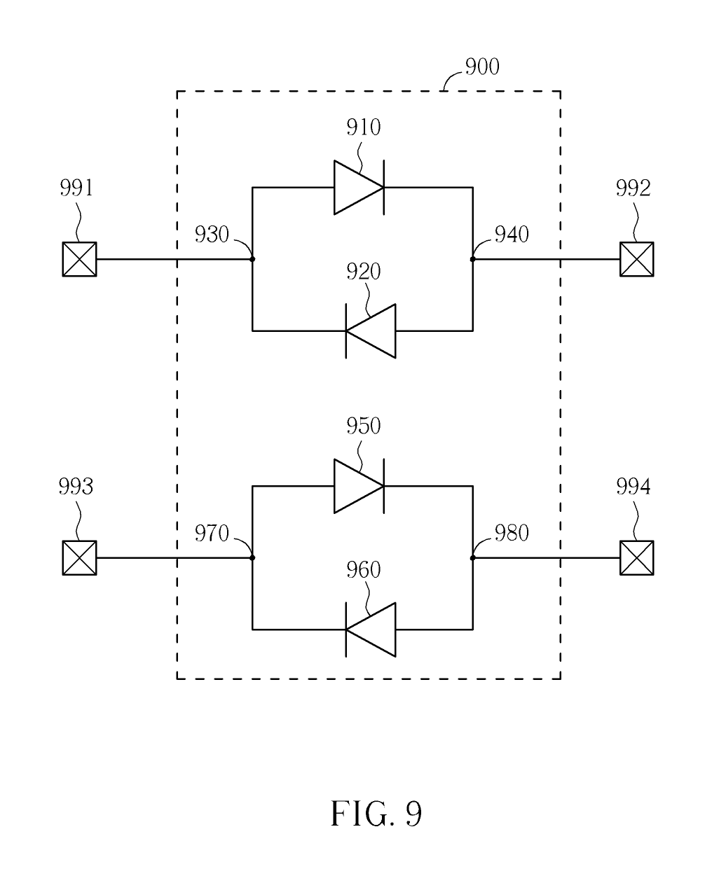

Please refer to FIG. 9. FIG. 9 is a diagram illustrating a power cut cell having four connecting nodes according to an exemplary embodiment of the present invention. The power cut cell 900 may have a first diode 910, a second diode 920, a first connecting node 930 and a second connecting node 940 for connecting a first power node 991 to a second power node 992, wherein the first power node 991 corresponds to a first power domain different from a second power domain to which the second power node 992 belongs. Moreover, the power cut cell 900 may include a third diode 950, a fourth diode 960, a third connecting node 970 and a fourth connecting node 980. The connecting nodes 970 and 980 can be respectively connected to ground nodes (first ground node 993 and second ground node 994) of first and second power domains.

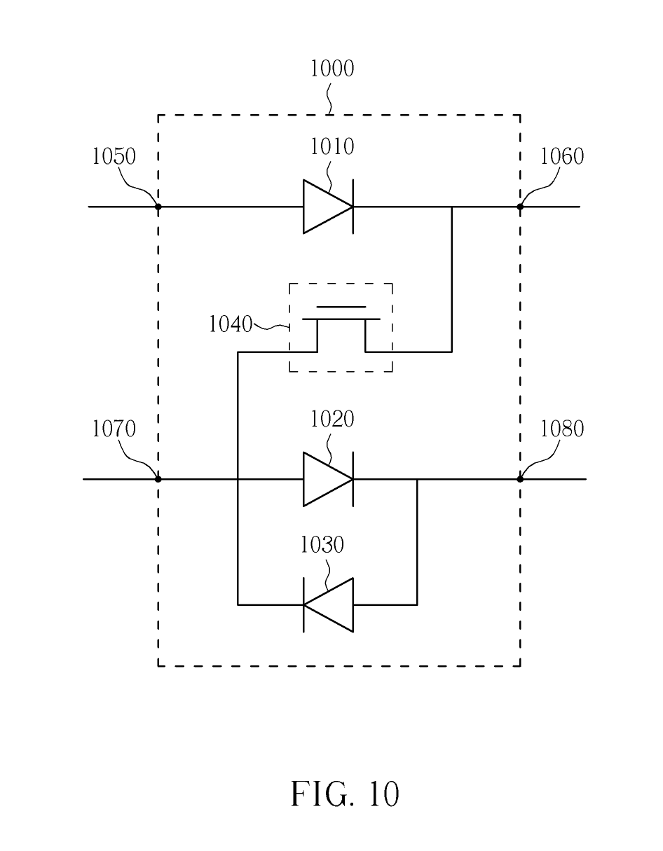

Please refer to FIG. 10. FIG. 10 is a diagram illustrating a power cut cell having four connecting nodes according to another exemplary embodiment of the present invention. The power cut cell 1000 has electric elements 1010, 1020, 1030, 1040, and four connecting nodes 1050, 1060, 1070, and 1080 for connecting power nodes and ground nodes of two different power domains. Please note that the circuit structure of aforementioned power cut cells are not meant to be a limitation of the present invention, and all the alternative designs of power cut cell for connecting circuits under two power domains and providing ESD paths obey and fall within the scope of the present invention. Since operation details of the power cut cells 900 and 1000 can be easily understood after reading the paragraphs above, further descriptions are omitted here for the sake of brevity.

Though the first and second I/O blocks shown in the embodiments above are belonged to different power domains, they could operate under a same power domain as well. For example, two I/O blocks can be coupled to different grounds while being coupled to the same power supply and thus operate under a same power domain. A power cut cell can be placed to provide an ESD path between I/O blocks even when the I/O blocks operate under the same power domain. No matter what power domain the I/O blocks belong to, a power cut cell providing ESD path between the I/O blocks placed in the core area or not sandwiched in between the I/O blocks obeys and falls within the scope of the present invention.

In conclusion, exemplary embodiments of the present invention provide chips each having reduced area without sacrificing ESD protection devices. That is, a new placement concept of ESD protection device is proposed to have a power cut cell placed in the core area or not sandwiched in between I/O blocks in the I/O area. By adopting the concept of the present invention for relocation of power cut cells, chip area could be greatly reduced especially when the chip is a pad-limited design. In order to prevent degrading of ESD immunity level, a total width of each connector between I/O blocks and power cut cells is preferred to be kept at a desired value. With the new placement concept, a chip which is pad-limited design and needs 7 power cut cells could have 2.97% and 4.45% area reduction in the chip area and core area, respectively. To put it simply, the more the power cut cells required, the more area reduction can be achieved.

Those skilled in the art will readily observe that numerous modifications and alterations of the device and method may be made while retaining the teachings of the invention.

What is claimed is:

1. A chip, comprising:
an input/output (I/O) area, having a first I/O block operated under a first power domain and a second I/O block operated under a second power domain placed therein, wherein a voltage range of the first power domain is distinct from a voltage range of the second power domain; and
a core area having at least one circuit therein performing at least one function of the chip, further having at least one power cut cell placed therein wherein the power cut cell is coupled to the first I/O block and the second I/O block via a plurality of connectors for providing an electrostatic discharge (ESD) path between the first I/O block and the second I/O block.

2. The chip of claim 1, wherein the plurality of connectors comprises connectors respectively connecting the power cut cell between a first power node of the first I/O block and between a second power node of the second I/O block.

3. The chip of claim 1, wherein the plurality of connectors comprises connectors respectively connecting the power cut cell between a first ground node of the first I/O block and a second ground node of the second I/O block.

4. The chip of claim 1, wherein the plurality of connectors comprises connectors respectively connecting the power cut cell between a first power node of the first I/O block and a first ground node of the second I/O block.

5. The chip of claim 1, wherein a total width of each of the connectors corresponds to a particular ESD tolerance level.

6. The chip of claim 5, wherein the total width of each of the connectors is not less than 5 um when the particular ESD tolerance level is not less than 50V.

7. The chip of claim 5, wherein at least one of the plurality of connectors is only routed on a single metal layer.

8. The chip of claim 5, wherein at least one of the plurality of connectors is routed on a plurality of metal layers.

9. The chip of claim 5, wherein at least one of the plurality of connectors is a bonding wire.

10. The chip of claim 1, wherein the chip is pad limited.

11. The chip of claim 1, wherein the plurality of connectors comprises a connector connected between a first connecting node of the power cut cell and a second connecting node of one of the first I/O block and the second I/O block, and a resistance of the connector is less than 5 ohm.

12. A chip, comprising:
a plurality of I/O blocks, including a first I/O block and a second I/O block operated under a first power domain and a second power domain, respectively, wherein a voltage range of the first power domain is distinct from a voltage range of the second power domain; and
at least one power cut cell, coupled to the first I/O block and the second I/O block via a plurality of connectors for providing an electrostatic discharge (ESD) path between the first I/O block and the second I/O block, where the at least one power cut cell is not sandwiched in between the first I/O block and the second I/O block.

13. The chip of claim 12, wherein the plurality of connectors comprises connectors respectively connecting the power cut cell between a first power node of the first I/O block and a second power node of the second I/O block.

14. The chip of claim 12, wherein the plurality of connectors comprises connectors respectively connecting the power cut cell between a first ground node of the first I/O block and a second ground node of the second I/O block.

15. The chip of claim 12, wherein the plurality of connectors comprises connectors respectively connecting the power cut cell between a first power node of the first I/O block and a first ground node of the second I/O block.

16. The chip of claim 12, wherein a total width of each of the connectors corresponds to a particular ESD tolerance level.

17. The chip of claim 16, wherein the total width of each of the connectors is not less than 5 um when the particular ESD tolerance level is not less than 50V.

18. The chip of claim 16, wherein at least one of the plurality of connectors is only routed on a single metal layer.

19. The chip of claim 16, wherein at least one of the plurality of connectors is routed on a plurality of metal layers.

20. The chip of claim 16, wherein at least one of the plurality of connectors is a bonding wire.

21. The chip of claim 12, wherein the chip is pad limited.

22. The chip of claim 12, wherein the plurality of connectors comprises a connector connected between a first connecting node of the power cut cell and a second connecting node of one of the first I/O block and the second I/O block, and, a resistance of the connector is less than 5 ohm.

23. A chip, comprising:
an input/output (I/O) area, having a first I/O block and a second I/O block placed therein operated under a same power domain; and
a core area having at least one circuit therein performing at least one function of the chip, further having at least one power cut cell placed therein wherein the power cut cell is coupled to the first I/O block and the second I/O block via a plurality of connectors for providing an electrostatic discharge (ESD) path between the first I/O block and the second I/O block.

24. A chip, comprising:
a plurality of I/O blocks, including a first I/O block and a second I/O block operated under a same power domain; and
at least one power cut cell, coupled to the first I/O block and the second I/O block via a plurality of connectors for providing an electrostatic discharge (ESD) path between the first I/O block and the second I/O block, where the at least one power cut cell is not sandwiched in between the first I/O block and the second I/O block.
